(19) United States
(12) Patent Application Publication
(10) Pub. No.: US 2015/0292587 A1
(43) Pub. Date: Oct. 15, 2015

(54) IMPACT RELIEVING DEVICE

(71) Applicant: Jianqing SHEN, (US)

(72) Inventor: Jianqing SHEN, Tongxiang CIty, Zhejiang (CN)

(73) Assignee: Jianqing SHEN, Tongxiang City, Zhejiang (CN)

(21) Appl. No.: 14/381,830

(22) PCT Filed: Sep. 28, 2012
(86) PCT No.: PCT/CN2012/082317

§ 371 Date: Aug. 28, 2014

(30) Foreign Application Priority Data
Sep. 26, 2012 (CN) 201210366589.8

(51) Int. Cl. F16F 1/36; B63B 59/02; E02B 3/26; B60R 19/02

(52) U.S. Cl. CPC F16F 1/36; B60R 19/023; B63B 59/02; E02B 3/26; B63B 2231/48

(57) ABSTRACT

An impact relieving device includes an impact portion and a fixed portion. The impact relieving device has an integral structure that is formed by one-step extrusion molding. The impact portion includes an inner layer and an outer layer. The inner layer and the outer layer are separated by a separation rib to form a cavity. The outer layer of the impact portion is arc-shaped, and an arc surface protrudes outwards. The impact relieving device has low manufacturing cost, is easy to manufacture and install, has a simple structure, and can effectively relieve an impact force.

### FIELD OF THE INVENTION

The present invention relates to an impact relieving device, in particular an impact relieving device to be used for ships and vehicles. For example, the device is used for a bumper of the vehicle or a fender beam of the ship. It can also be applied to other places which need to prevent the collision force, such as a highway crash barrier or a port terminal guardrail and so on.

### BACKGROUND TO THE INVENTION

It is easy to collide in the process of using ships and vehicles. When a collision occurs, it may bring about the serious accidents which cause casualties and property losses due to the guard outside of the hull or body set unreasonable or unprotected devices.

The Ministry of Industry and Information Technology released the 2011 China Automotive Industry Announcements economic performance. In 2011, China's auto market achieved a steady growth in car production and sales to over 18.4 million, again setting the world record. According to the China Association of Automobile Manufacturers, China 2011 cumulative automotive production was 18,418,900, an increase of 0.8%, and automotive sales were 18,505,100, an increase of 2.5%. Data show that in 2011, in strictly prohibited drunk driving, the vehicle population reached 104 million in China, there were 6.2 million people deaths by car accident. According to 2012 national conference on transportation, in 2011 there were 298 transport vessel traffic accidents, 291 people dead and missing, 2150 search and rescue ships in distress, 18,712 people were rescued, with rescue success rate of 96.7%. It can be seen from the above data that the accident incidence is very high. Because the protection device is not effective, car crashes often occur. Currently the most common method is a protective ring which is setting around the lateral margin or an insurance rack around the outer margin. Then a rubber layer is set on an insurance shelf. But the protection devices of two methods of the prior art are made of rubber or soft plastic which are coated on the hull's outer side. The impact could be reduced to a certain extent. But this reduction degree is lower and the effect is minimal.

China utility model patent No. ZL01217833.0 discloses a collision safety cushion hull body. The main body of the buffer is semicircular cross section, circular, or trapezoidal. There are mounting holes on the main body throughout the upper end surface of the body from the mounting hole to the lower face. A topcoat of the body has yellow and white reflective paint at an end of a strip, which is fixed by screws to the hull. The ship collision safety cushion body can only be set in a specific position. If the cushion body is installed around the hull, high costs results and hinders the forward speed of the hull.

China invention patent application No. CN93111409.8 discloses a kind of buffer method and device in ship collision. A flexible buffer device in ship collision is installed around a hull. It is connected with an automatic opening and closing door on the hull and is flexible or angle transformation. This kind of device could use a single form or a multiple combination forms of hydraulic, pneumatic, spring and machinery. But the operation of this device and method is complicated and there is a high cost. In the case of early warning it could reduce the impact. But it does not work when meeting a sudden collision.

British invention patent No. GB99815571.3 discloses an impact resistant layer structure, such as double vessel side portion including an outer shell and an inner shell plate panels. A group of malleable material is set and disposed vertically or stacked with each other, and is fixed to the inner surface of the outer shell plate against the ends of their passage through the side wall structure. Each base of the channel at least is connected with the internal shell by a structure basically perpendicular to the base's girder or with a structure thereof. This collision-resistant device's structure is complex with a long production time and complex processing.

### SUMMARY OF THE INVENTION

In order to overcome the defects in the prior art, the present invention provides an impact relieving device which could effectively reduce and diffuse a collision impact on a vehicle or a hull. The device has the advantages of simple manufacturing, reasonable structure, low cost and could effectively reduce the collision impact.

In accordance with the present invention, there is provided an impact relieving device including an impact portion (1) and a fixed portion (2), wherein the impact relieving device is an integral structure of integrated molding, the impact portion (1) includes an inner layer (3) and an outer layer (4), the inner layer (3) and the outer layer (4) are separated by a separation rib (5) to form a cavity (6), and the outer layer (4) of the impact portion is arc-shaped and a curved surface protrudes outward.

Preferably, the fixed portion (2) and an inside wall of the impact portion (1) form a fixed slot (10); and the fixed slot (10) is located on the top of the impact relieving device.

Preferably, a prominent block or a groove is equipped on the inside wall of the inner layer (3) of the impact portion (1); and the prominent block or the groove of the inner layer is equipped on a vehicle or a hull; the prominent block or the groove of the impact portion (1) maintains a constant connection with a corresponding groove or the prominent block of the vehicle or the hull.

Preferably, an insert block is respectively equipped on the both ends of the cavity (6); and an interference fit is between the insert block and the cavity (6).

Preferably, an outer layer of two adjacent cavities (6) is the outer layer (4) of the impact portion (1).

Preferably, a groove is equipped between the outer layer of the two adjacent cavities (6) to separate the cavities; and an outer layer of the two adjacent grooves is in arc shape and the curved surface bulges outward.

Preferably, a wall of the inner layer (3) of the impact portion (1) which contacts the vehicle or the hull is planar.

Preferably, the wall is made up of multiple planes and the relative position between the planes gradually increases or decreases from top to bottom.

Preferably, the relative position between the planes is not in the same plane.

Preferably, a tail which contracts inward is equipped on the bottom of the impact portion (1); and there is an angle between the tail and the impact portion and the angle is between 60-150 degrees.

Preferably, a location hole (8) is equipped on the separation rib (5) between the inner layer (3) and the outer layer (4) of the impact portion (1); and the axis of the location hole (8) and the axis of the cavity (6) are parallel to each other.

Preferably, a through hole (9) is equipped on the fixed portion (2); and the axis of the through hole (9) and the axis of the cavity (6) are parallel to each other.

Preferably, a trend of the cavity (6) is the same with a trend of fixed slot (10).

Preferably, the impact relieving device is made of flexible plastics.

Preferably, the impact relieving device is made of rubber.

In comparison with the prior art, the impact relieving device according to the present invention has a low cost, easy manufacture and installation, and simple structure. In particular, it could effectively reduce the crash impact. It could reduce the damage to the vehicles or ships or other machine equipments using the described device in the present invention and increase the staff's safety.

### BRIEF DESCRIPTION OF THE DRAWINGS

FIG. 1 is a three dimensional structure view of a preferred embodiment of the impact relieving device in accordance with the present invention;

FIG. 2 is the front view of the device of FIG. 1;

FIG. 3 is the top view of the device of FIG. 1.

### DETAILED DESCRIPTION OF PREFERRED EMBODIMENTS

The invention will now be described, by way of example, with reference to the following drawings in which.

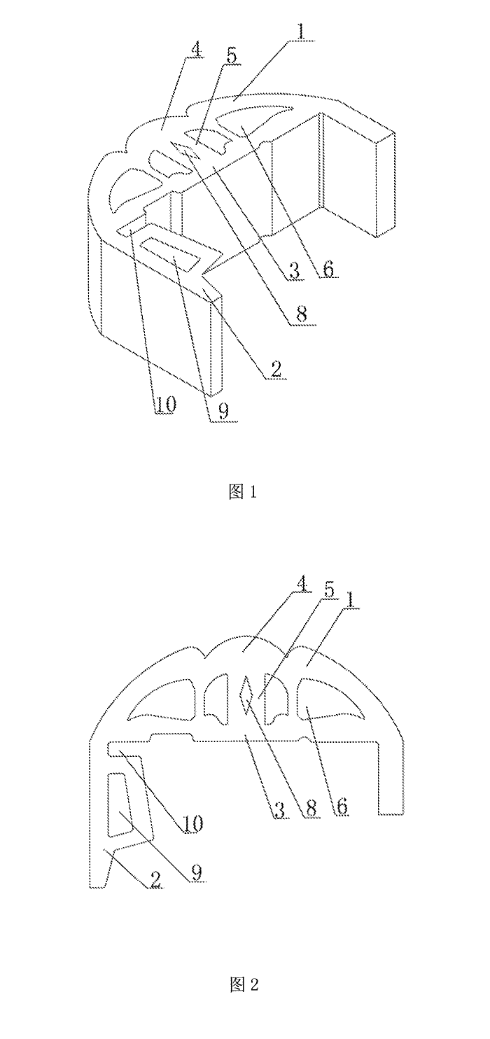

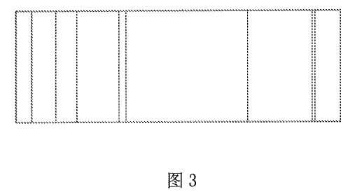

Referring to FIGS. 1 to 2, in accordance with an embodiment of the present invention, there is provided an impact relieving device comprising an impact portion 1 and a fixed portion 2. The impact relieving device has an integral structure that is formed by one-step extrusion molding. Preferably, the impact relieving device is made of flexible plastics or rubber. When the device is made of the above described materials, it greatly reduces the collision force when the device is conflicted. The larger restoring force is formed and it has scored remarkable effects. The impact portion 1 includes an inner layer 3 and an outer layer 4. The inner layer (3) and the outer layer (4) are separated by a separation rib (5) to form a cavity (6). The outer layer 4 of the impact portion is arc-shaped and a curved surface protrudes outward. The fixed portion 2 and an inside wall of the impact portion 1 form a fixing slot 10 at a top side of the impact relieving device.

Referring to FIGS. 2 to 3, a prominent block or a groove is equipped on the inside wall of the inner layer 3 of the impact portion 1. A groove or a prominent block which is fitted together with the prominent block or the groove of the inner layer is equipped on a vehicle or a hull, the prominent block or the groove of the impact portion 1 maintains a constant connection with the vehicle or the hull. An insert block is respectively equipped on the both ends of the cavity 6 and an interference fit is between the insert block and the cavity 6. The outer layer 4 of the impact portion is arc-shaped and a curved surface bulges outward.

An outer layer of the two adjacent cavities 6 is the outer layer 4 of the impact portion 1. A groove is equipped between the outer layer of the two adjacent cavities 6 to separate the cavities and an outer layer of the two adjacent grooves is in arc shape and the curved surface bulges outward. A wall of the inner layer 3 of the impact portion 1 which is contacted with the vehicle or the hull is planar. The wall is made up of multiple planes and the relative position between the planes progressively incremented or decremented from top to bottom. The relative position between the planes is not in the same plane. A tail which contracts inward is equipped on the bottom of the impact portion 1 and the angle between the tail and the impact portion is 90 degree. According to the different applications of the impact relieving device, the angle is between 60-150 degrees. A location hole 8 is equipped on the separation rib 5 between the inner layer 3 and the outer layer 4 of the impact portion 1 and the axis of the location hole 8 and the axis of the cavity 6 are parallel to each other. A through hole 9 is equipped on the fixed portion 2 and the axis of the through hole 9 and the axis of the cavity 6 are parallel to each other. A trend of the cavity 6 is the same with a trend of fixed slot 10.

It will be readily apparent to persons skilled in the relevant arts that various modifications and improvements may be made to the foregoing embodiments, in addition to those already described, without departing from the basic inventive concepts of the present invention.

1. An impact relieving device comprising: an impact portion and a fixed portion, with the impact relieving device having an integral one-step extrusion molding structure, the impact portion including an inner layer and an outer layer, a separation rib located between the inner layer and the outer layer to define a cavity there between, the outer layer of the impact portion having an arc shape with a curved surface protruding outwards.

2. The impact relieving device in accordance with claim 1, wherein the fixed portion and an inside wall of the impact portion form a fixed slot, and the fixed slot is located on the top of the impact relieving device.

3. The impact relieving device in accordance with claim 1, wherein is equipped on the inside wall of the inner layer of the impact portion includes a wall section groove or a prominent block which is adapted for fitment against an opposing wall section on a vehicle hull, and the wall section of the impact portion maintains a constant connection with the opposing wall section of the vehicle.

4. The impact relieving device in accordance with claim 1, wherein an insert block is respectively equipped on the both ends of the cavity and an interference fit is between the insert block and the cavity.

5. The impact relieving device in accordance with claim 1, the separation rib further defining a second cavity adjacent the cavity and between the inner layer and the outer layer, wherein an outer layer of the two adjacent cavities is the outer layer of the impact portion.

6. The An-impact relieving device in accordance with claim 5, further comprising a groove between the outer layer of the two adjacent cavities to separate the cavities and an outer layer of the two adjacent grooves is arc-shaped and the arc surface protrudes outward.

7. The impact relieving device in accordance with claim 1, wherein a wall of the inner layer of the impact portion which is contacted with the vehicle is planar.

8. The impact relieving device in accordance with claim 7, wherein the wall is made up of multiple planes and the relative position between the planes gradually increases or decreases from top to bottom.

9. The impact relieving device in accordance with claim 8, wherein the relative position between the planes is not in the same plane.

10. The impact relieving device in accordance with claim 1, wherein a tail extends from the bottom of the impact portion at an angle is between 60-150 degrees from a wall of the inner layer.

11. The impact relieving device in accordance with claim 1, wherein the separation rib defines a location bore between the inner layer and the outer layer of the impact portion; and an axis of the location bore is parallel to an axis of the cavity.

12. The impact relieving device in accordance with claim 1, wherein the fixed portion defines a through aperture having an axis parallel to an axis of the cavity.

13. The impact relieving device in accordance with claim 2, wherein a trend of the cavity is the same with a trend of the fixed slot.

14. The impact relieving device in accordance with claim 1, wherein the impact relieving device is made of flexible plastics.

15. The impact relieving device in accordance with claim 1, wherein the impact relieving device is made of rubber.

16. The impact relieving device in accordance with claim 3, wherein the wall section of the impact portion includes at least one of a prominent block and a groove, and the opposing wall section of the vehicle includes at least one of a corresponding prominent block and a groove.

17. The impact relieving device in accordance with claim 3, wherein the opposing wall section of the vehicle is a hull.
